(19) United States
(12) Patent Application Publication
(10) Pub. No.: US 2026/0058162 A1
(43) Pub. Date: Feb. 26, 2026

(54) ANODE PROTECTIVE LAYER COMPRISING LITHIOPHILIC MATERIAL COATED WITH CARBON LAYER DOPED WITH NITROGEN AND ALL SOLID- STATE BATTERY COMPRISING SAME

(71) Applicant: Factorial Inc., Billerica, MA (US)

(72) Inventors: Weixuan Xu, Woburn, MA (US); Fang Hao, Andover, MA (US); Takaaki Miki, Malden, MA (US); Hyun Seok Kim, Lexington, MA (US)

(21) Appl. No.: 19/297,691

(22) Filed: Aug. 12, 2025

Related U.S. Application Data
(60) Provisional application No. 63/686,298, filed on Aug. 23, 2024.

(51) Int. Cl. H01M 4/62; H01M 10/058

(52) U.S. Cl. CPC H01M 4/628; H01M 10/058

(57) ABSTRACT

Disclosed is an all-solid-state battery (ASSB) comprising an anode layer, an anode protective layer, a solid electrolyte layer, and a cathode layer in the order, wherein the anode protective layer comprises a carbonaceous material and a particle of a lithiophilic material at least partially coated by a carbon layer doped with nitrogen. In some embodiments, the ASSB comprising the anode protective layer exhibits an improved electrochemical performance.

### CROSS-REFERENCE

The present application claims the benefit of U.S. Ser. No. 63/686,298, filed Aug. 23, 2024, the entire content of which is incorporated herein by reference into this application.

### FIELD

The present disclosure is generally related to an anode protective layer for an all solid-state battery (ASSB).

### BACKGROUND

All-solid-state batteries (ASSBs) are being extensively studied due to their better safety and higher energy density in comparison to liquid-electrolyte based lithium-ion batteries. ASSBs include a solid electrolyte (SE) layer between a cathode layer and an anode layer, wherein the SE layer comprises an inorganic ion conductor such as inorganic oxide or sulfide electrolyte. The SE layer functions as both electrolyte and separator. However, formation and growth of lithium dendrite may penetrate an SE layer and cause short-circuit, thus leading to a shortened life of ASSB. Thus, there remains a need for new ASSBs and methods for preparing the same.

### SUMMARY

The present disclosure provides an all solid-state battery (ASSB) comprising an anode layer, an anode protective layer, a solid electrolyte (SE) layer, and a cathode layer in the order, wherein the anode protective layer comprises a particle of a lithiophilic material coated with a carbon layer doped with nitrogen. In some embodiments, the ASSB comprising the anode protective layer exhibits an improved electrochemical performance. In some embodiments, an anode protective layer (alternatively anode interlayer or anode sublayer) is a layer or sublayer disposed between an SE layer and an anode active material layer (or anode current collector). Without wishing to be bound by any theory, such anode protective layer may protect the anode layer, SE layer or both.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 illustrates a representative configuration of an ASSB with an anode protective layer according to one embodiment of the present disclosure.

FIG. 2 illustrates another representative configuration of an ASSB with an anode protective layer according to one embodiment of the present disclosure.

FIG. 3 illustrates a representative configuration of an ASSB with an anode protective layer according to one embodiment of the present disclosure.

FIG. 4 shows XRD patterns of particles of lithiophilic materials coated with a carbon layer doped with nitrogen and particles of a lithiophilic material without coated carbon according to some embodiments of the present disclosure.

FIG. 5 shows an SEM image of particles of a lithiophilic material coated with carbon doped with nitrogen according to one embodiment of the present disclosure.

FIG. 6 shows an SEM image of a cross-section of an anode according to another embodiment of the present disclosure.

FIGS. 7A, 7B and 7C show the specific capacities, capacity retention rates and columbic efficiencies (CEs) of cells during cycling, respectively, according to some embodiments of the present disclosure.

### DETAILED DESCRIPTION

Disclosed is an all-solid-state battery (ASSB) comprising a cathode layer, a solid electrolyte layer, an anode protective layer and an anode layer in the order, wherein the anode protective layer comprises a carbonaceous material and a particle of a lithiophilic material coated with a carbon layer doped with nitrogen. In some embodiments, the ASSB comprising the anode protective layer exhibits a longer cycling life and an improved electrochemical performance.

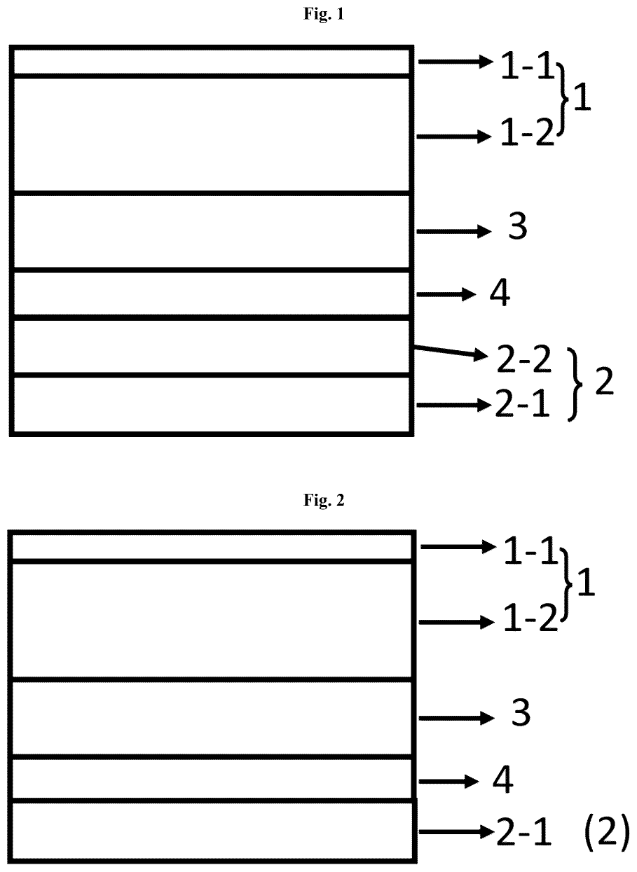

In one embodiment, an ASSB comprises a cathode layer (1), an anode layer (2), a solid electrolyte (SE) layer (3), and an anode protective layer (4) between the SE layer (3) and the anode (2) as shown in FIGS. 1 and 2. In some embodiments, the anode protective layer (4) comprises a first lithiophilic material that is alloyable with lithium. In some embodiments, the anode layer (2) comprises an anode current collector (2-1) and optionally an anode active material layer (2-2). In some embodiments, the cathode layer (1) comprises a cathode current collector (1-1) and a cathode active material layer (1-2).

In some embodiments, the anode layer (2) comprises an anode current collector (2-1) and an anode active material layer (2-2) prior to the first charge as shown in FIG. 1. In some embodiments, the anode layer (2) comprises an anode current collector (2-1) without an anode active material layer (2-2) prior to the first charge as shown in FIG. 2. In some embodiments, an anode active material layer (2-2) is formed after the first charge.

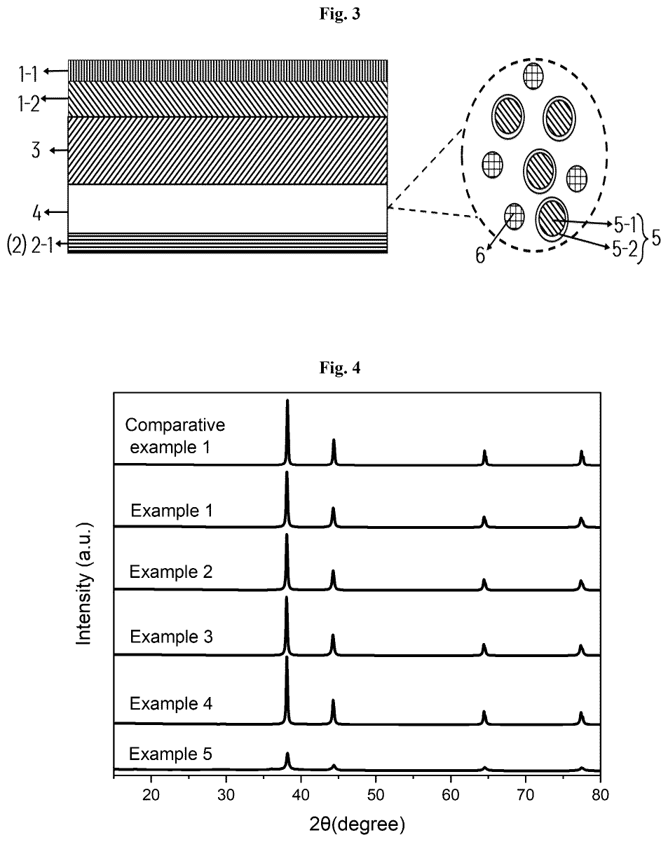

In some embodiments, the anode protective layer (4) may be a single layer or a multi-layered structure. In some embodiments, the anode protective layer (4) is a single layer comprising the particle of a lithiophilic material. As shown in FIG. 3, the anode protective layer (4) is a single layer comprising particles of a lithiophilic material (5-1) coated with a carbon layer doped with nitrogen (5-2) (5-1 and 5-2, collectively 5) and a carbonaceous material (6).

In some embodiments, the content of carbon of a particle surface of a coated lithiophilic material is from about 0.1 wt % to about 10.0 wt %, from about 0.1 wt % to about 8.0 wt %, from about 0.1 wt % to about 6.0 wt %, from about 0.1 wt % to about 5.0 wt %, from about 0.1 wt % to about 4.0 wt %, from about 0.5 wt % to about 10.0 wt %, from about 0.5 wt % to about 8.0 wt %, from about 0.5 wt % to about 6.0 wt %, from about 0.5 wt % to about 5.0 wt %, from about 0.5 wt % to about 4.0 wt %, from about 1.0 wt % to about 10.0 wt %, from about 1.0 wt % to about 8.0 wt %, from about 1.0 wt % to about 6.0 wt %, from about 1.0 wt % to about 5.0 wt %, from about 1.0 wt % to about 4 wt %, from about 1.5 wt % to about 10.0 wt %, from about 1.5 wt % to about 8.0 wt %, from about 1.5 wt % to about 6.0 wt %, from about 1.5 wt % to about 5.0 wt %, or from about 1.5 wt % to about 4.0 wt % based on a total content of the surface as determined by an SEM-energy dispersive X-ray (EDX) spectroscopy.

In some embodiments, the content of carbon of a surface of the particle of a coated lithiophilic material is greater than 0. In some embodiments, the content of carbon of the particle surface is no less than 0.1 wt %, no less than 0.3 wt %, no less than 0.5 wt %, no less than 0.7 wt %, no less than 1.0 wt %, no less than 1.2 wt %, no less than 1.5 wt %, or no less than 2.0 wt %. In some embodiments, the content of carbon of the particle surface is no greater than 5.5 wt %, no greater than 5.0 wt %, no greater than 4.5 wt % or no greater than 4.0 wt %. In some embodiments, the content of carbon of the particle surface is in a range from 0.1 wt % to 5.5 wt %, from 0.1 wt % to 5.0 wt %, from 0.1 wt % to 4.5 wt %, from 0.1 wt % to 4.0 wt %, from 0.1 wt % to 3.5 wt %, from 0.2 wt % to 5.5 wt %, from 0.2 wt % to 5.0 wt %, from 0.2 wt % to 4.5 wt %, from 0.2 wt % to 4.0 wt %, from 0.5 wt % to 5.0 wt %, from 0.5 wt % to 4.5 wt %, from 0.5 wt % to 4.0 wt %, from 0.7 wt % to 5.5 wt %, from 0.7 wt % to 5.0 wt %, from 0.7 wt % to 4.5 wt %, from 0.7 wt % to 4.0 wt %, from 1.0 wt % to 5.5 wt %, from 1.0 wt % to 5.0 wt %, from 1.0 wt % to 4.5 wt %, from 1.0 wt % to 4.0 wt %, from 1.5 wt % to 5.5 wt %, from 1.5 wt % to 5.0 wt %, from 1.5 wt % to 4.5 wt %, from 1.5 wt % to 4.0 wt %, from 2.0 wt % to 5.5 wt %, from 2.0 wt % to 5.0 wt %, from 2.0 wt % to 4.5 wt % or from 2.0 wt % to 4.0 wt % based on a total content of the surface of the particle surface as determined by an SEM-EDX spectroscopy.

In some embodiments, the content of nitrogen of the particle surface is from about 0.1 wt % to about 10.0 wt %, from about 0.1 wt % to about 8.0 wt %, from about 0.1 wt % to about 6.0 wt %, from about 0.1 wt % to about 4.0 wt %, from about 0.1 wt % to about 3.0 wt %, from about 0.1 wt % to about 2.5 wt %, from about 0.1 wt % to about 2.0 wt %, from about 0.5 wt % to about 10.0 wt %, from about 0.5 wt % to about 8.0 wt %, from about 0.5 wt % to about 6.0 wt %, from about 0.5 wt % to about 4.0 wt %, from about 0.5 wt % to about 3.0 wt %, from about 0.5 wt % to about 2.5 wt %, from about 0.5 wt % to about 2.0 wt %, from about 1.0 wt % to about 10.0 wt %, from about 1.0 wt % to about 8.0 wt %, from about 1.0 wt % to about 6.0 wt %, from about 1.0 wt % to about 4.0 wt %, from about 1.5 wt % to about 10.0 wt %, from about 1.5 wt % to about 8.0 wt %, about 1.5 wt % to about 6.0 wt %, or from about 1.5 wt % to about 4.0 wt % based on a total content of the particle surface as determined by an SEM-EDX spectroscopy.

In some embodiments, the content of nitrogen of a particle surface of a coated lithiophilic material is greater than 0. In some embodiments, the content of nitrogen of the particle surface is no less than 0.1 wt %, no less than 0.2 wt %, no less than 0.3 wt %, no less than 0.4 wt %, or no less than 0.5 wt %. In some embodiments, the content of nitrogen of the particle surface is no greater than 6.0 wt %, no greater than 5.5 wt %, no greater than 5.0 wt %, no greater than 4.5 wt %, no greater than 4.0 wt %, no greater than 3.5 wt %, or no greater than 3.0 wt %. In some embodiments, the content of nitrogen of a particle surface of a coated lithiophilic material is in a range from 0.1 wt % to 6.0 wt %, from 0.1 wt % to 5.5 wt %, from 0.1 wt % to 5.0 wt %, from 0.1 wt % to 4.5 wt %, from 0.1 wt % to 4.0 wt %, from 0.1 wt % to 3.5 wt %, from 0.1 wt % to 3.0 wt %, from 0.1 wt % to 2.5 wt %, from 0.2 wt % to 6.0 wt %, from 0.2 wt % to 5.5 wt %, from 0.2 wt % to 5.0 wt %, from 0.2 wt % to 4.5 wt %, from 0.2 wt % to 4.0 wt %, from 0.2 wt % to 3.5 wt %, from 0.2 wt % to 3.0 wt %, from 0.2 wt % to 2.5 wt %, from 0.3 wt % to 6.0 wt %, from 0.3 wt % to 5.5 wt %, from 0.3 wt % to 5.0 wt %, from 0.3 wt % to 4.5 wt %, from 0.3 wt % to 4.0 wt %, from 0.3 wt % to 3.5 wt %, from 0.3 wt % to 3.0 wt %, from 0.3 wt % to 2.5 wt %, from 0.4 wt % to 6.0 wt %, from 0.4 wt % to 5.5 wt %, from 0.4 wt % to 5.0 wt %, from 0.4 wt % to 4.5 wt %, from 0.4 wt % to 4.0 wt %, from 0.4 wt % to 3.5 wt %, from 0.4 wt % to 3.0 wt %, or from 0.4 wt % to 2.5 wt % based on a total content of the particle surface as determined by an SEM-EDX spectroscopy.

In some embodiments, the content of oxygen of a surface of the particle of a coated lithiophilic material is from about 1.0 wt % to about 10.0 wt %, from about 1.0 wt % to about 8.0 wt %, from about 1.0 wt % to about 6.0 wt %, from about 1.0 wt % to about 4.0 wt %, from about 1.0 wt % to about 3.0 wt %, from about 1.0 wt % to about 2.5 wt %, from about 1.0 wt % to about 2.0 wt %, from about 1.2 wt % to about 10.0 wt %, from about 1.2 wt % to about 8.0 wt %, from about 1.2 wt % to about 6.0 wt %, from about 1.2 wt % to about 4.0 wt %, from about 1.2 wt % to about 3.0 wt %, from about 1.2 wt % to about 2.5 wt %, from about 1.2 wt % to about 2.0 wt %, from about 1.4 wt % to about 10.0 wt %, from about 1.4 wt % to about 8.0 wt %, from about 1.4 wt % to about 6.0 wt %, from about 1.4 wt % to about 4.0 wt %, from about 1.4 wt % to about 3.0 wt %, from about 1.4 wt % to about 2.5 wt %, or from about 1.4 wt % to about 2.0 wt % based on a total content of the particle surface as determined by an SEM-EDX spectroscopy.

In some embodiments, the content of oxygen of a particle surface of a coated lithiophilic material is greater than 1.0 wt %. In some embodiments, the content of oxygen of the particle surface is no greater than 10.0 wt %, no greater than 9.0 wt %, no greater than 8.0 wt %, no greater than 7.5 wt %, no greater than 7.0 wt %, no greater than 6.5 wt %, no greater than 6.0 wt %, no greater than 5.5 wt %, no greater than 5.0 wt %, no greater than 4.5 wt %, no greater than 4.0 wt %, no greater than 3.5 wt %, no greater than 3.0 wt % or no greater than 2.5 wt %. In some embodiments, the content of oxygen of the particle surface is in a range from 1.1 wt % to 6.5 wt %, from 1.1 wt % to 5.5 wt %, from 1.1 wt % to 5.0 wt %, from 1.1 wt % to 4.5 wt %, from 1.1 wt % to 4.0 wt %, from 1.1 wt % to 3.5 wt %, from 1.1 wt % to 3.0 wt %, from 1.1 wt % to 2.5 wt %, from 1.2 wt % to 6.5 wt %, from 1.2 wt % to 5.5 wt %, from 1.2 wt % to 5.0 wt %, from 1.2 wt % to 4.5 wt %, from 1.2 wt % to 4.0 wt %, from 1.2 wt % to 3.5 wt %, from 1.2 wt % to 3.0 wt %, from 1.2 wt % to 2.5 wt %, from 1.3 wt % to 6.5 wt %, from 1.3 wt % to 5.5 wt %, from 1.3 wt % to 5.0 wt %, from 1.3 wt % to 4.5 wt %, from 1.3 wt % to 4.0 wt %, from 1.3 wt % to 3.5 wt %, from 1.3 wt % to 3.0 wt %, from 1.3 wt % to 2.5 wt %, from 1.4 wt % to 6.5 wt %, from 1.4 wt % to 5.5 wt %, from 1.4 wt % to 5.0 wt %, from 1.4 wt % to 4.5 wt %, from 1.4 wt % to 4.0 wt %, from 1.4 wt % to 3.5 wt %, from 1.4 wt % to 3.0 wt %, or from 1.4 wt % to 2.5 wt % based on a total content of the particle surface as determined by an SEM-EDX spectroscopy.

In some embodiments, the carbon layer on the particle of a lithiophilic material has a thickness in a range from 0.5 nm to 20.0 nm, from 0.5 nm to 15.0 nm, from 0.5 nm to 10.0 nm, from 0.5 nm to 7.0 nm, from 0.5 nm to 5.0 nm, from 0.5 nm to 3.0 nm, from 1.0 nm to 30.0 nm, from 1.0 nm to 20.0 nm, from 1.0 nm to 15.0 nm, from 1.0 nm to 10.0 nm, from 1.0 nm to 7.0 nm, from 1.0 nm to 5.0 nm, from 1.0 nm to 3.0 nm, or any and all subranges and ranges therebetween.

In some embodiments, the particle size of the lithiophilic material core is in a range from 20 nm to 100 nm, from 20 nm to 80 nm, from 20 nm to 60 nm, from 20 nm to 40 nm, from 30 nm to 100 nm, from 30 nm to 80 nm, from 30 nm to 60 nm, from 50 nm to 100 nm, from 50 nm to 80 nm, from 50 nm to 60 nm, or any and all subranges and ranges therebetween.

In some embodiments, the particle of the lithiophilic material has an average crystalline particle size in a range from 20 nm to 100 nm, wherein the average crystalline particle size is calculated by Debye-Scherrer equation: Kλ/β Cos θ, wherein K is the Scherrer constant (0.9), λ denotes the wavelength of the radiation source, β is the full width at half maximum (FWHM) of the peak with the highest intensity and θ is a diffraction angel. In some embodiments, the peak with the highest density has a 2θ of 37.9°. In some embodiments, the average crystalline particle size of the lithiophilic material particle is greater than 30 nm, greater than 32 nm, greater than 35 nm, greater than 37 nm, greater than 40 nm or greater than 42 nm. In some embodiments, the average crystalline particle size of the lithiophilic material particle is 100 nm or less, 90 nm or less, 80 nm or less, 70 nm or less, 65 nm or less, 60 nm or less, 58 nm or less, 55 nm or less, or 53 nm or less. In some embodiments, the average crystalline particle size of the lithiophilic material particle is in a range from 31 nm to 70 nm, from 32 nm to 70 nm, from 35 nm to 70 nm, from 37 nm to 70 nm, from 40 nm to 70 nm, from 42 nm to 70 nm, from 31 nm to 60 nm, from 32 nm to 60 nm, from 35 nm to 60 nm, from 37 nm to 60 nm, from 40 nm to 60 nm, from 42 nm to 60 nm, from 31 nm to 55 nm, from 32 nm to 55 nm, from 35 nm to 65 nm, from 37 nm to 65 nm, from 40 nm to 65 nm, from 42 nm to 65 nm, from 31 nm to 50 nm, from 32 nm to 50 nm, from 35 nm to 50 nm, from 37 nm to 50 nm, from 40 nm to 50 nm, or from 42 nm to 50 nm.

In some embodiments, the carbon layer on the particle of a lithiophilic material is an amorphous carbon, a crystalline carbon, or a mixture thereof.

In some embodiments, the anode protective layer (4) may have two or more sublayers.

In some embodiments, the carbonaceous material in the anode protective layer comprises at least one selected from the group consisting of carbon black, acetylene black, Ketjen black, channel black, furnace black, lamp black, thermal black, natural graphite and artificial graphite.

In some embodiments, the carbonaceous material has a weigh percentage in a range from 60 wt % to 90 wt %, from 60 wt % to 85 wt %, from 60 wt % to 80 wt %, from 65 wt % to 90 wt %, from 65 wt % to 85 wt %, from 65 wt % to 80 wt %, from 70 wt % to 90 wt %, from 70 wt % to 85 wt %, or from 70 wt % to 80 wt % in the anode protective layer.

In some embodiments, the lithiophilic material in the anode protective layer comprises at least one elementary substance selected from the group consisting of Ag, Zn, Ti, Cd, Mg, Al, Ga, Si, Ge, In, Sn, Pb, Bi, Sb, oxides, sulfides, fluorides, nitrides, chlorides, and carbides thereof, and mixtures thereof. In some embodiments, the lithiophilic material is in the form of particles. In some embodiments, the particles of the lithiophilic material have a median particle size (D50) in a range from 20 nm to 100 nm in the anode protective layer. In some embodiments, the lithiophilic material has a weight percentage in the anode protective layer in a range from 10 wt % to 35 wt %, from 10 wt % to 30 wt %, from 10 wt % to 25 wt %, from 15 wt % to 35 wt %, from 15 wt % to 30 wt %, from 15 wt % to 25 wt %, from 20 wt % to 35 wt %, from 20 wt % to 30 wt %, or from 20 wt % to 25 wt % in the anode protective layer in the anode protective layer. In some embodiments, the lithiophilic material has a weight percentage of no greater than 10 wt % in the anode protective layer. In some embodiments the anode protective layer is substantially free of the lithiophilic material.

In some embodiments, the particles of a lithiophilic material coated with a carbon layer doped with nitrogen can be prepared by various synthesis methods, such as thermal pyrolysis, hydrothermal method, solvothermal method, chemical vapor deposition, etc. In the thermal pyrolysis method, a metal salt and a nitrogen-containing carbon source are commonly used as precursors. The pyrolysis temperature is in a range of 100° C. to 800° C. in a reductive gas (for example, mixture of Ar and H₂ or mixture of N₂ and H₂) for a period.

In some embodiments, the metal salt can be chosen from: metal acetate, metal nitrate, metal chloride, metal sulfate, metal carbonate, metal oxide, metal fluoride, etc.

In some embodiments, the nitrogen-containing carbon source can be chosen from: urea, melamine, cyanamide, pyridine, acrylonitrile, acetonitrile, phthalocyanine, polyacrylonitrile (PAN), polyaniline, biomass, etc.

In some embodiments, the anode protective layer has a thickness in a range from 0.5 μm to 50.0 μm, from 0.5 μm to 40.0 μm, from 0.5 μm to 30.0 μm, from 0.5 μm to 20.0 μm, from 0.5 μm to 15.0 μm, from 0.5 μm to 10.0 μm, from 0.5 μm to 5.0 μm, from 1.0 μm to 50.0 μm, from 1.0 μm to 40.0 μm, from 1.0 μm to 30.0 μm, from 1.0 μm to 20.0 μm, from 1.0 μm to 15.0 μm, from 1.0 μm to 10.0 μm, from 1.0 μm to 5.0 μm, or any and all subranges and ranges therebetween.

In some embodiments, the carbonaceous material in the anode protective layer has a volume percentage of at least 50 vol %, at least 60 vol % or at least 70 vol % so that the particles of the lithiophilic material are distributed in a matrix of the carbonaceous material.

In some embodiments, the anode protective layer further comprises a polymeric binder. In some embodiments, the polymeric binder is present in a weight percentage in a range from 2.0 wt % to 10.0 wt % in the anode protective layer. In some embodiments, the polymeric binder comprises at least one selected from the group consisting of polyacrylate, styrene-butadiene rubber (SBR), polytetrafluoroethylene) (PTFE), poly(vinylidene fluoride) (PVDF), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, arylate copolymer, cellulose acetate, cellulose acetate butyrate, cellulose acetate propionate, polysaccharide polymer and carboxyl methyl cellulose, or a combination thereof.

A solid electrolyte layer (alternatively, solid electrolyte membrane or electrolyte film) refers to a thin structure that allows transportation or flow of ions and prevents electronic contact between a cathode and an anode. A solid electrolyte layer has a typical thickness in a range from 5 μm to 300 μm.

In some embodiments, the solid electrolyte is an oxide-based solid electrolyte or a sulfide-based electrolyte. In one embodiment, the solid electrolyte has a formula LiₓM1_{y}M2_{z}P₁₋ₚM3ₚS_{6-a-b-q}O_{q}ClₐBr_{b} (Formula I), wherein 4≤x≤8, 0≤y<1, 0≤z<1, 0≤p<1, 0≤q<1, 0≤a≤2, 0≤b<2, 0<6-a-b-q<6, 0<1-p≤1, wherein M1 is at least one element of Group 1 or Group 11 other than H or Li of the periodic table, M2 is at least one element of Group 2 of the periodic table, and M3 is at least one element of Group 14 of the periodic table.

In some embodiments, the solid electrolytes has a formula LiₓM1_{y}M2_{z}P₁₋ₚM3ₚS_{6-a-b-q}O_{q}ClₐBr_{b} (Formula I), wherein 4≤x≤8, 0≤y<1, 0≤z<1, 0≤p<1, 0≤q<1, 0≤a≤2, 0≤b<2, 0<6-a-b-q<6, 0<1-p≤1, and wherein M1 is at least one element of Group 1 or Group 11 other than H or Li of the periodic table, M2 is at least one element of Group 2 of the periodic table, and M3 is at least one element of Group 14 of the periodic table.

In some embodiments, M1 is at least one selected from the group consisting of Na, K, Rb, Cs, Cu, Ag, and Au. In some embodiments, M2 is at least one selected from the group consisting of Be, Mg, Ca, Sr, and Ba. In some embodiments, M3 is at least one selected from the group consisting of Si, Ge, Sn, and Pb.

In some embodiments, b/a has a value in a range from 0 to 20, i.e, 0≤b/a≤20.

In some embodiments, the formula of sulfide solid electrolyte in the electrolyte layer, i.e., LiₓM1_{y}M2_{z}P₁₋ₚM3ₚS_{6-a-b-q}O_{q}ClₐBr_{b}, does not comprise any of M1, M2, M3 or O, i.e., y=z=p=q=0, corresponding to a formula of LiₓPS_{6-a-b}ClₐBr_{b}.

In some embodiments, the formula of the sulfide electrolyte comprises at least one element selected from the group consisting of M1, M2, M3 and O. In some embodiments, the Formula (I) contains one element selected from the group consisting of M1, M2, M3 and O. In some embodiments, Formula I is selected from the group consisting of:
1) LiₓM1_{y}PS_{6-a-b}ClₐBr_{b}, where 4≤x≤8, 0<y<1, 0≤a≤2, 0≤b<2, 0<6-a-b<6;
2) LiₓM2_{z}PS_{6-a-b}ClₐBr_{b}, where 4≤x≤8, 0<z<1, 0≤a≤2, 0<b<2, 0<6-a-b<6;
3) LiₓP₁₋ₚM3ₚS_{6-a-b}ClₐBr_{b}, where 4≤x≤8, 0<p≤1, 0≤a≤2, 0≤b<2, 0<6-a-b<6, 0<1-p<1; and
4) LiₓPS_{6-a-b-q}O_{q}ClₐBr_{b}, where 4≤x≤8, 0<q≤1, 0≤a≤2, 0<b<2, 0<6-a-b-q<6.

In some embodiments, the Formula (I) contains O and one element selected from the group consisting of M1, M2, and M3. In some embodiments, the sulfide solid electrolyte has a formula selected from the group consisting of LiₓM1_{y}PS_{6-a-b-q}O_{q}ClₐBr_{b} (4≤x≤8, 0<y<10≤q<1, 0<a≤2, 0<b<2, 0<6-a-b-q<6), LiₓM2_{z}P₁S_{6-a-b-q}O_{q}ClₐBr_{b} (4≤x≤8, 0<z<1, 0<q<1, 0<a≤2, 0≤b<2, 0<6-a-b-q<6,), and LiₓP₁₋ₚM3ₚS_{6-a-b-q}O_{q}ClₐBr_{b} (45≤x≤8, 0<p<1, 0≤q<1, 0≤a≤2, 0≤b<2, 0<6-a-b-q<6, 0<1-p<1). In one embodiment, the Formula (I) contains O without M1, M2, or M3. In one embodiment, the formula of the sulfide electrolyte is LiₓPS_{6-a-b-q}O_{q}ClₐBr_{b} (45≤x≤8, 0<q<1, 0≤a≤2, 0≤b<2, 0<6-a-b-q<6). In some embodiments, M1 is at least one element of Group 1 or Group 11 other than H or Li of the periodic table. In some embodiments, M1 is at least one selected from the group consisting of Na, K, Rb, Cs, Cu, Ag, and Au. In some embodiments, M2 is at least one element of Group 2 of the periodic table. In some embodiments, M2 is at least one selected from the group consisting of Be, Mg, Ca, Sr, and Ba. In some embodiments, M3 is at least one element of Group 14 of the periodic table. In some embodiments, M3 is at least one selected from the group consisting of Si, Ge, Sn, and Pb.

In one embodiment, the sulfide solid electrolyte has a formula of LiₓPS_{6-a-b-q}O_{q}ClₐBr_{b}, where 4≤x≤8, 0<q≤1, 0≤a≤2, 0<b<2, 0<6-a-b-q<6. The incorporation of oxygen into the formula makes such material more stable. In some embodiments, the molar amount of O with q having a value in a range from 0 to 0.1, from 0 to 0.2, from 0 to 0.3, from 0 to 0.4, from 0 to 0.5, from 0 to 0.6, from 0.001 to 0.1, from 0.001 to 0.2, from 0.001 to 0.3, from 0.001 to 0.4, from 0.001 to 0.5, from 0.001 to 0.6, from 0.002 to 0.1, from 0.002 to 0.2, from 0.002 to 0.3, from 0.002 to 0.4, from 0.002 to 0.5, from 0.002 to 0.6, from 0.005 to 0.1, from 0.005 to 0.2, from 0.005 to 0.3, from 0.005 to 0.4, from 0.005 to 0.5, from 0.005 to 0.6, or any and all ranges and subranges therebetween. In one embodiment, the formula is Li_{5.8}PS_{4.7}O_{0.1}Cl_{1.2}.

In some embodiments, the formula is LiₓPS_{6-a-b-q}O_{q}ClₐBr_{b}, wherein 4≤x≤8, 0<q≤1, 0≤a≤2, 0<b<2, 0<6-a-b-q<6. In some embodiments, b/a has a value higher than zero. In some embodiments, b/a has a value in a range from 0 to 3.5. In some embodiments, b/a has a value in a range from 0 to 7. In some embodiments, b/a has a value in a range from 0 to 10, from 0 to 15, or from 0 to 20.

In some embodiments, when the formula is LiₓM1_{y}PS_{6-a-b-q}ClₐBr_{b}, 45≤x≤8, 0<y<1, 0≤a≤2, 0<b<2, 0<6-a-b<6, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In some embodiments, when the formula is LiₓM2_{z}PS_{6-a-b}ClₐBr_{b}, where 4≤x≤8, 0<z≤1, 0≤a≤2, 0<b<2, 0<6-a-b<6, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In one embodiment, when the formula is LiₓP₁₋ₚM3ₚS_{6-a-b}ClₐBr_{b}, 43≤x≤8, 0<p<1, 0≤a≤2, 0≤b<2, 0<6-a-b<6, 0<1-p<1, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In some embodiments, the Formula (I) contains O and one element selected from the group consisting of M1, M2, and M3. In some embodiments, the sulfide solid electrolyte has a formula selected from the group consisting of LiₓM1_{y}PS_{6-a-b-q}O_{q}ClₐBr_{b} (4≤x≤8, 0<y<1, 0<q<1, 0<a≤2, 0<b<2, 0<6-a-b-q<6), LiₓM2_{z}PS_{6-a-b-q}O_{q}ClₐBr_{b} (4≤x≤8, 0<z<1, 0<q<1, 0≤a≤2, 0b<2, 0<6-a-b-q<6,), and LiₓP₁₋ₚM3ₚS_{6-a-b-q}O_{q}ClₐBr_{b} (4≤x≤8, 0<p<1, 0<q<1, 0≤a≤2, 0≤b<2, 0<6-a-b-q<6, 0<1-p<1). In one embodiment, the Formula (I) contains O without M1, M2, or M3. In one embodiment, the formula of the sulfide electrolyte is LiₓPS_{6-a-b-q}O_{q}ClₐBr_{b} (4≤x≤8, 0<q<1, 0≤≤2, 0≤b<2, 0<6-a-b-q<6). In some embodiments, the molar amount of Br in the formula has a value higher than zero, i.e., b>0.

In some embodiments, the total molar amount of the halogen in the formula of sulfide electrolyte is no more than 2, i.e., a+b≤2. In one embodiment, the total molar amount of the halogen in the formula is no less than 2 and no more than 3, i.e., 2≤a+b≤3. In one embodiment, the total molar amount of the halogen in the formula is no less than 2 and less than 4, i.e., 2≤a+b<4. In one embodiment, the total molar amount of Br and Cl in the formula is no more than 2, i.e., a+b≤2, no less than 2 and no more than 3, i.e., 2≤a+b≤3, or no less than 2 and less than 4, i.e., 2≤a+b<4.

In some embodiments, the sulfide solid electrolyte has a formula selected from the group consisting of:
1) LiₓPS_{6-a-b}ClₐBr_{b}, where 4≤x≤8, 0≤a≤2, 0<b<2, 0<6-a-b<6;
2) LiₓM1_{y}PS_{6-a-b}ClₐBr_{b}, where 4≤x≤8, 0<y<1, 0≤a≤2, 0<b<2, 0<6-a-b<6;
3) LiₓM2_{z}PS_{6-a-b}ClₐBr_{b}, where 4≤x≤8, 0<z<1, 0≤a≤2, 0≤b<2, 0<6-a-b<6;
4) LiₓP₁₋ₚM3ₚS_{6-a-b}ClₐBr_{b}, where 4≤x≤8, 0<p<1, 0≤a≤2, 0<b<2, 0<6-a-b<6, 0<1-p<1;
5) LiₓPS_{6-a-b-q}O_{q}ClₐBr_{b}, where 4≤x≤8, 0<q≤1, 0<a≤2, 0<b<2, 0<6-a-b-q<6;
6) LiₓM1_{y}PS_{6-a-b-q}O_{q}ClₐBr_{b}, where 4≤x≤8, 0<y<1, 0<q<1, 0≤a≤2, 0≤b<2, 0<6-a-b-q<6;
7) LiₓM2_{z}PS_{6-a-b-q}O_{q}ClₐBr_{b}, where 4≤x≤8, 0<z<1, 0≤q<1, 0≤a≤2, 0≤b<2, 0<6-a-b-q<6;
8) LiₓP₁₋ₚM3ₚS_{6-a-b-q}O_{q}ClₐBr_{b}, where 4≤x≤8, 0<p<1, 0<q<1, 0≤a≤2, 0≤b<2, 0<6-a-b-q<6, 0<1-p<1; and mixtures thereof.

In some embodiments, the solid electrolyte layer has a thickness in a range from 5 μm to 300 μm, from 10 μm to 300 μm, from 20 μm to 300 μm, from 50 μm to 300 μm, from 5 μm to 200 μm, from 10 μm to 200 μm, from 20 μm to 200 μm, from 50 μm to 200 μm, from 5 μm to 100 μm, from 10 μm to 100 μm, from 20 μm to 100 μm, from 50 μm to 100 μm, from 5 μm to 50 μm, from 10 μm to 50 μm, from 20 μm to 50 μm, or any and all ranges and subranges therebetween.

In some embodiments, the solid electrolyte layer has a lithium-ion conductivity of no less than 0.05 mS/cm, no less than 0.1 mS/cm, no less than 0.2 mS/cm, no less than 0.5 mS/cm, no less than 0.75 mS/cm, no less than 1 mS/cm, no less than 2 mS/cm, or no less than 5 mS/cm, no less than 7.5 mS/cm or no less than 10 mS/cm. In some embodiments, the solid electrolyte layer has a lithium-ion conductivity in a range from 0.05 mS/cm to 10 mS/cm, from 0.1 mS/cm to 10 mS/cm, from 0.25 mS/cm to 10 mS/cm, from 0.5 mS/cm to 10 mS/cm, from 0.75 mS/cm to 10 mS/cm, from 1 mS/cm to 10 mS/cm, from 2 mS/cm to 10 mS/cm, from 0.05 mS/cm to 7.5 mS/cm, from 0.1 mS/cm to 7.5 mS/cm, from 0.25 mS/cm to 7.5 mS/cm, from 0.5 mS/cm to 7.5 mS/cm, from 0.75 mS/cm to 7.5 mS/cm, from 1 mS/cm to 7.5 mS/cm, from 2 mS/cm to 7.5 mS/cm, from 0.05 mS/cm to 5 mS/cm, from 0.1 mS/cm to 5 mS/cm, from 0.25 mS/cm to 5 mS/cm, from 0.5 mS/cm to 5 mS/cm, from 0.75 mS/cm to 5 mS/cm, from 1 mS/cm to 5 mS/cm, or any and all ranges and subranges therebetween.

In one embodiment, the cathode active material layer of an ASSB comprises a cathode active material. In some embodiments, the ASSB has a relatively high cathode loading. In some embodiments, the ASSB has a cathode loading of at least 5.0 mAh/cm², at least 5.5 mAh/cm², at least 6.0 mAh/cm², at least 6.5 mAh/cm², at least 6.8 mAh/cm², at least 7.2 mAh/cm², or at least 7.5 mAh/cm². A high cathode loading is critical to achieve a high energy density. However, a battery with a high cathode loading may be subject to a relatively fast decay, which ultimately leads to a lower capacity retention. In some embodiments, the present disclosure provides an ASSB having both a high cathode loading and a good cycling performance.

In some embodiments, the ASSB exhibits an initial specific capacity of at least 145 mAh/g at a rate of 0.33 C at a temperature of 45° C. In some embodiments, the ASSB is tested at a pressure in a range from 0.5 MPa to 5.0 MPa.

In some embodiments, the cycling test can be performed at other C rates such as C/6, C/4, C/2, C, 1C, 2C, 3C, 5C, or any intermediate rate therebetween. In some embodiments, the cycling test can be performed at other temperatures such as −20° C., −10° C., 0° C., 10° C., 20° C. 25° C., 30° C., 40° C., 50° C., 80° C., or any intermediate temperature therebetween. Cycle life is determined by the number of cycles for the battery cell to reach a threshold value such as 80% of its original capacity and is usually used to measure the cycling performance of a secondary battery. In some embodiments, the ASSB comprising the anode protective layer exhibits a cycle life which is at least 10%, at least 15%, at least 20%, at least 25%, at least 30%, at least 40%, at least 50%, or at least 60% longer than that of the ones without carbon coating doped with nitrogen.

In some embodiments, the ASSB exhibits a capacity retention rate of at least 92.00%, at least 94.00%, at least 96.00%, at least 97.00%, at least 98.00%, at least 98.50%, at least 99.00%, at least 99.50%, at least 99.75% or at least 99.90% after at least 50 cycles at a rate of 0.33 C/0.33 C at 45° C.

In some embodiments, after 50 cycles at a rate of 0.33 C/0.33 C at a temperature of 45° C., the ASSB exhibits a specific capacity of at least 140 mAh/g, at least 145 mAh/g, at least 150 mAh/g, at least 155 mAh/g, at least 160 mAh/g, or at least 165 mAh/g.

In some embodiments, the ASSB exhibits an average CE of at least 99.40%, at least 99.45%, at least 99.50%, at least 99.55%, at least 99.60%, at least 99.65%, at least 99.70%, at least 99.75%, or at least 99.80% for the first 50 cycles at a rate of 0.33 C/0.33 C at a temperature of 45° C.

In one embodiment, the cathode active material layer in the cathode layer of an ASSB comprises a cathode electroactive material. In one embodiment, the cathode active material contains Li, Ni, and Co. In one embodiment, the cathode active material contains Li, Ni, and Co and at least one of Mn and Al. In one embodiment, the cathode active material contains at least one of Fe, and P.

In one embodiment, the cathode active material experiences a redox reaction at a potential of 2 V or above over Li/Li⁺ during operation of an ASSB.

In some embodiments, the anode active material layer comprises an anode active material such as lithium metal or a lithium alloy. In some embodiments, the anode active material comprises at least one selected from the group consisting of lithium, sodium, magnesium, aluminum, silicon, calcium, titanium, manganese, iron, cobalt, nickel, zinc, molybdenum, silver, indium, tin, and tungsten. In some embodiments, the anode active material layer also includes a carbon-based conductive material with a weight percentage in a range from 1 wt % to 30 wt %. In some embodiments, the carbon-based conductive material in the anode active material layer comprises at least one selected from the group consisting of carbon black, acetylene black, Ketjen black, channel black, furnace black, lamp black, thermal black, natural graphite and artificial graphite.

In one aspect, the present disclosure provides a method for preparing an anode protective layer. The method comprises:
1) Preparing a mixture comprising a solvent, a carbonaceous material and a lithiophilic material at least partially coated by a carbon coating doped with nitrogen, and
2) Coating the mixture to a substrate followed by drying, thus obtaining an anode protective layer, wherein the anode protective layer comprises the carbonaceous material and the particle of a lithiophilic material at least partially coated with a carbon layer doped with nitrogen is distributed in a matrix of the carbonaceous material.

In some embodiments, the carbonaceous material is carbon black. In some embodiments, the substrate is an anode current collector or a detachable base such as peelable film.

In some embodiments, the anode current collector is an SUS (stainless steel) foil.

In some embodiments, the mixture further comprises a polymeric binder as disclosed herein.

In some embodiments, the solvent is a nonaqueous solvent. In some embodiments, the solvent comprises at least one selected from the group consisting of N-methylpyrrolidone (NMP), 1,3-dioxolane, 2,5,7,10-tetraoxaundecane, and mixtures thereof.

In some embodiments, the solvent has a weight percentage ranging from 25% to 75% in the mixture. In some embodiments, the mixture is in a form of slurry. In some embodiments, the mixture is in a dough-like form.

In some embodiments, the present disclosure provides a method for preparing an all-solid-state battery (ASSB), the method comprising:
1) having an anode layer comprising an anode current collector and an anode protective layer, wherein the anode protective layer comprises a carbonaceous material and a particle of a lithiophilic material at least partially coated with a carbon layer doped with nitrogen and the particle of the lithiophilic material is distributed in a matrix of the carbonaceous material, and
2) laminating the anode layer with the anode protective layer, a solid electrolyte layer, and a cathode layer in the order wherein the anode protective layer is located between the anode current collector and the solid electrolyte layer, thereby obtaining an ASSB comprising the anode layer, the solid electrolyte layer and the cathode layer.

In some embodiments, the anode protective layer is a structure with a gradient concentration, wherein the anode protective layer contains particles of a lithiophilic material at least partially coated with a carbon layer doped with nitrogen with a decreasing or increasing concentration gradient along a first direction along the thickness direction, wherein the first direction is defined as the direction the SE layer faces toward an anode.

In some embodiments, the anode layer, the anode protective layer, the solid electrolyte layer and the cathode layer are laminated or assembled under a warm isostatic pressing (WIP) process. In some embodiments, the WIP is conducted under a pressure in a range from 100 MPa to 500 MPa. In some embodiments, the WIP is performed at a temperature in a range from 20° C. to 100° C.

The disclosure will be better understood by reference to the Experimental Details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

### Example 1

Preparation of Particles of a Lithiophilic Material at Least Partially Coated with a Carbon Layer Doped with Nitrogen

Particles of a lithiophilic material at least partially coated with a carbon layer doped with nitrogen can be prepared by a thermal pyrolysis method using a metal salt and a nitrogen-containing carbon source as precursors. Anhydrous silver acetate and urea were chosen as the silver precursor and the carbon precursor, respectively, to synthesize silver particles coated with a carbon layer doped with nitrogen (denoted as Ag@CNx). The mixture of silver precursor and carbon precursor was heated at 260° C. in a furnace under flowing forming gas (3% H₂+97% N₂). Silver particles coated with a carbon layer doped with nitrogen (Ag@CNx) were collected after the furnace was turned off and cooled down. Example 1 (Ex. 1) was prepared with a weight ratio of silver precursor to carbon precursor at 100:5.

Example 2 (Ex. 2), Example 3 (Ex. 3), Example 4 (Ex. 4) and Example 5 (Ex. 5) were prepared in the same manner as in Example 1, except with a weight ratio of silver precursor to carbon precursor at 100:8, 100:12.5, 100:20 and 100:50, respectively.

Comparative example 1 was similarly prepared except only using silver precursor without any carbon precursors.

TABLE 1
Composition of the lithiophilic material in the
anode protective layer and precursor ratio

| | | Ratio of silver precursor to |
|---|---|---|
| Example | Composition | carbon precursor (w/w) |
| Comparative example 1 | Ag | 100:0 |
| Example 1 | Ag@CNx | 100:5 |
| Example 2 | Ag@CNx | 100:8 |
| Example 3 | Ag@CNx | 100:12.5 |
| Example 4 | Ag@CNx | 100:20 |
| Example 5 | Ag@CNx | 100:50 |

### XRD and Crystalline Particle Size Analysis

X-ray diffraction (XRD) spectra were taken on a Rigaku XRD instrument, collecting over 20 from 15 degree to 80 degree at a scan rate of 5 degree/min.

FIG. 4 shows the XRD patterns of particles of Ag coated with a carbon layer doped with nitrogen as well as pure Ag particles without coated carbon layer. Examples 1-5 and Comparative example 1 exhibited typical metallic Ag single phase with the cubic crystal structure.

Average crystalline Ag particle size was calculated based on the XRD data using Debye-Scherrer equation. Examples 1 through 4 had a similar average crystalline Ag particle size to Comparative example 1, while Example 5 showed a smaller crystalline Ag particle size.

TABLE 2
Average crystalline Ag particle size

| | Average crystalline Ag |
|---|---|
| Example | particle size (nm) * |
| Comparative example 1 | 51.1 |
| Example 1 | 45.5 |
| Example 2 | 47.8 |
| Example 3 | 49.8 |
| Example 4 | 53.2 |
| Example 5 | 31.3 |

* Average crystalline particle size is calculated by Debye-Scherrer equation: D = Kλ/βCosθ, where D is the nanoparticles crystalline size, K is the Scherrer constant (0.9), λ denotes the wavelength (1.54 Å for Cu Kα radiation), β is the full width at half maximum (FWHM) of the peak with the highest intensity, i.e., at 37.9° of 2θ, and θ is the diffraction angle of the peak with the highest intensity.

### SEM and Elemental Analysis

Scanning electron microscopy (SEM) images and energy-dispersive X-ray (EDX) analysis were taken on a Thermo Scientific electron microscopy at 10.0 kV and 65 pA.

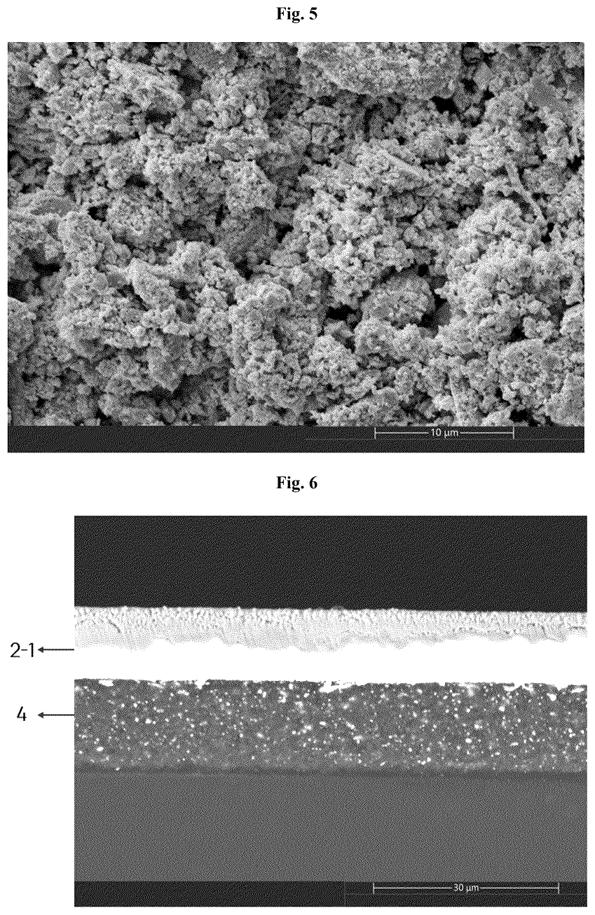

FIG. 5 shows an SEM image of Ag particles coated with a carbon layer doped with nitrogen (Example 3).

### Preparation of Anode Protective Layer and Assembly of ASSB

A slurry was prepared by mixing the as-prepared Ag particles coated with a carbon layer doped with nitrogen (Ag@CNx), carbon black (CB) as the carbonaceous material, polyvinylidene fluoride (PVDF) as binder and N-methylpyrrolidone (NMP) as solvent. An anode protective layer was formed by applying the slurry to an SUS (stainless steel) foil with a thickness of 10 μm as anode current collector using a bar-coating method followed by drying in a convection oven. The thickness of the anode protective layer on the anode current collector was 15˜20 μm.

TABLE 3
Elemental composition

| Example | Ag wt % | C wt % | N wt % | O wt % |
|---|---|---|---|---|
| Comparative example 1 | 99.0 | 0.0 | 0.0 | 1.0 |
| Example 1 | 94.1 | 3.1 | 1.4 | 1.4 |
| Example 2 | 93.7 | 3.2 | 1.6 | 1.5 |
| Example 3 | 93.5 | 3.1 | 1.7 | 1.6 |
| Example 4 | 92.7 | 3.5 | 2.0 | 1.8 |
| Example 5 | 81.7 | 5.1 | 5.7 | 7.5 |

An anode protective layer of comparative example 1 was also prepared in the same manner except that silver particle was not coated.

A cell comprising a cathode (85 wt % CAM) with a cathode loading of around 6.8 mAh/cm², an anode as prepared above, and an SE layer was assembled and sealed in a pouch followed by an isostatic pressing, leading to a pouch cell.

### Assembly of Cells and Testing

Cells comprising a cathode layer, an anode layer with an anode protective layer and a solid electrolyte layer were assembled and sealed in a pouch followed by an isostatic pressing (IP).

FIG. 6 shows an SEM image of a cross-section of Example 3 (Ex. 3), wherein the anode protective layer (4) is adjacent to the anode current collector (2-1) and comprises carbon-coated particles of Ag as the lithiophilic material.

Cycling testing of the cells was conducted under 0.33 C/0.33 C continuously at 45° C. with an external pressure in a range from 0.5 MPa to 5.0 MPa, wherein each cycle charges to 4.25 V and discharges to 2.5V.

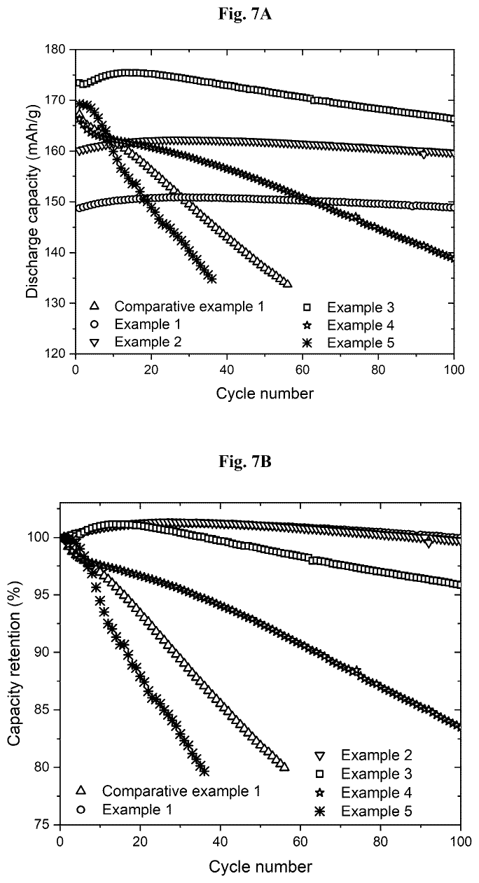

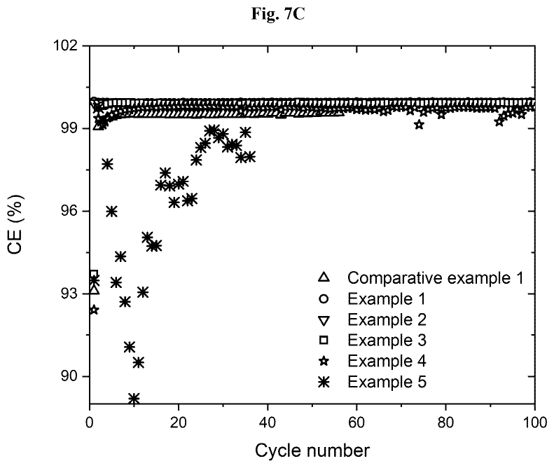

Specific capacity, capacity retention rate and columbic efficiency (CE) during the first 50 cycles and the first 100 cycles are shown in FIGS. 7A, 7B and 7C, respectively.

As shown in Table 4, the cell comprising comparative example 1 (Comp. Ex. 1), example 1 (Ex. 1), example 2 (Ex. 2) and example 3 (Ex. 3) exhibited a 1^{st} discharge specific capacity of 167.20 mAh/g, 148.95 mAh/g, 160.14 mAh/g, 173.48 mAh/g, 166.27 mAh/g and 169.28 mAh/g at 0.33 C, respectively.

TABLE 4
Cycling performance of examples and comparative example

| | DChg | | | | | | |
|---|---|---|---|---|---|---|---|
| | Cap. of | First 50 cycles | | | First 100 cycles | | |
| | 1^{st} Cycle | DChg | Cap. | Ave. | DChg | Cap. | Ave. |
| | @0.33 C | Cap. | Retn. | CE | Cap. | Retn. | CE |
| Example | (mAh/g) | (mAh/g) | (%) | (%) | (mAh/g) | (%) | (%) |
| Comparative | 167.20 | 136.97 | 81.92 | 99.37 | — | — | — |
| example 1 | | | | | | | |
| Example 1 | 148.95 | 150.46 | 101.02 | 99.93 | 148.87 | 99.95 | 99.94 |
| Example 2 | 160.14 | 161.84 | 101.07 | 99.94 | 159.68 | 99.72 | 99.94 |
| Example 3 | 173.48 | 171.80 | 99.03 | 99.79 | 166.31 | 95.86 | 99.86 |
| Example 4 | 166.27 | 153.80 | 92.50 | 99.57 | 138.80 | 83.48 | 99.63 |
| Example 5 | 169.28 | — | — | — | — | — | — |

As shown in FIGS. 7A and 7B, the cell with example 5 exhibited a poor cycling performance in comparison to comparative example 1. Without wishing to be bound by any theory, it may be ascribed to the thicker carbon coating layer, which limits the lithium-ion transport kinetics. It also supports that the thickness of the carbon coating layer plays an important role in regulating the discharge capacity. A thin carbon coating layer (from about 0.5 nm to 20 nm) can improve the stability of the active materials, while a thick coating layer causes limitations in kinetics. Therefore, tuning the ratio of metal precursor to carbon precursor to adjust the coating layer thickness is significant for rational design of coated materials.

After 50 cycles at 45° C. and at 0.33 C, the cells with examples 1, 2, 3 and 4 as anode protective layer exhibited a capacity retention rate of 101.02%, 101.07%, 99.03% and 92.50%, respectively. They are higher than that of the cell with comparative example 1 as anode protective layer with a capacity retention of 81.92%. Example 5, however, exhibited a capacity retention rate of 80% after around 35 cycles.

After 100 cycles at 45° C. and at 0.33 C, the cells with examples 1, 2, 3 and 4 as anode protective layer exhibited a capacity retention rate of 99.95%, 99.72%, 95.86% and 83.48%, respectively. Comparative example 1, however, exhibited a capacity retention rate of 79% after 56 cycles.

The average CE of the first 50 cycles of the cell with examples 1, 2, 3 and 4 as anode protection layer is 99.93%, 99.94%, 99.79% and 99.57%, respectively. They are higher than comparative example 1 which has an average CE of 99.37%. The average CE of the first 100 cycles of the cell with examples 1, 2, 3 and 4 as anode protection layer is 99.94%, 99.94%, 99.86% and 99.63%, respectively.

The result suggests that anode protective layer as disclosed herein the particle of the lithiophilic material coated with a relatively thin carbon layer doped with nitrogen can improve the capacity retention rate during cycling and elongate the cycle life.

On the one hand, the average crystalline particle size of the lithiophilic material plays a critical role. As shown in Tables 2 and 4, when the average crystalline particle size was lower than 35 nm, e.g., 31.3 nm of Example 5, the ASSB demonstrated a much worse performance. When the average crystalline particle size was greater than 35 nm, for example, Examples 1 through 4 had an average crystalline particle size of 45.5 nm, 47.8 nm, 49.8 nm and 53.2 nm, respectively. The ASSB exhibited a good discharge capacity, discharge capacity retention and average coulombic efficiency.

On the other hand, the surface chemistry of the particles of the lithiophilic material plays an important role. As shown in Tables 3 and 4, when the content of carbon of a surface of the coated particle of the lithiophilic material was too high, such as 5.1 wt % for Example 5, the ASSB exhibited a less desired performance. In contrast, Examples 1 through 4 had a relatively lower surface content of carbon, i.e., 3.1 wt %, 3.2 wt % and 3.1 wt %, respectively. The ASSB exhibited a good discharge capacity, discharge capacity retention and average coulombic efficiency.

### Aspects

In a first aspect, the present disclosure provides an anode protective layer for an all-solid-state battery (ASSB), comprising a carbonaceous material and a particle of a lithiophilic material at least partially coated with a carbon layer doped with nitrogen.

In a second aspect according to the first aspect, the content of carbon of a surface of the coated particle of the lithiophilic material is in a range from about 0.1 wt % to about 10.0 wt %, based on total content of the surface as determined by SEM-EDX. In some embodiments, the content of carbon of the particle surface is in a range from about 1.0 wt % to about 5.0 wt %, from about 1.0 wt % to about 4.5 wt %, from about 1.0 wt % to about 4.0 wt % or from about 1.0 wt % to about 3.5 wt % based on total content of the surface as determined by SEM-EDX.

In a third aspect according to the first or second aspect, the content of nitrogen of a surface of the coated particle of the lithiophilic material is from about 0.1 wt % to about 10 wt %, based on total content of the surface, when determined by SEM-EDX of a surface of the coated particle of the lithiophilic material. In some embodiments, the content of nitrogen of the particle surface is in a range from about 0.1 wt % to about 4.5 wt %, from about 0.2 wt % to about 4.5 wt %, from about 0.5 wt % to about 4.5 wt %, from about 1.0 wt % to about 4.5 wt %, from about 1.5 wt % to about 4.5 wt % or from about 2.0 wt % to about 4.5 wt % based on total content of the surface as determined by SEM-EDX.

In a fourth aspect according to any preceding aspect, the content of oxygen of a surface of the coated particle of the lithiophilic material is in a range from about 1.0 wt % to about 5.0 wt % based on total content of the surface as determined by SEM-EDX. In some embodiments, the content of oxygen of the particle surface is in a range from 1.2 wt % to 5.0 wt %, from 1.2 wt % to 4.5 wt %, from 1.2 wt % to 4.0 wt %, from 1.2 wt % to 3.5 wt %, from 1.2 wt % to 3.0 wt % or from 1.2 wt % to 2.5 wt % based on total content of the surface as determined by SEM-EDX.

In a fifth aspect according to any preceding aspect, the particle of the lithiophilic material has an average crystalline particle size in a range from 32 nm to 70 nm, wherein the average crystalline particle size is calculated by Debye-Scherrer equation: Kλ/β Cos θ, wherein K is the Scherrer constant (0.9), λ denotes the wavelength of the radiation source, β is the full width at half maximum (FWHM) of the peak with the highest density at a diffraction angel of θ. In some embodiments, the average crystalline particle size of the lithiophilic material particle is in a range from 35 nm to 70 nm, from 35 nm to 65 nm, from 35 nm to 60 nm, from 35 nm to 55 nm, from 40 nm to 70 nm, from 40 nm to 65 nm, from 40 nm to 60 nm, from 40 nm to 55 nm, from 45 nm to 70 nm, from 45 nm to 65 nm, from 45 nm to 60 nm or from 45 nm to 55 nm.

In a sixth aspect according to any preceding aspect, the content of the lithiophilic material of the coated particle of the lithiophilic material is in a range from 80.0 wt % to 98.5 wt %, based on total content of the particle surface as determined by SEM-EDX.

In a seventh aspect according to any preceding aspect, the lithiophilic material comprises at least one selected from the group consisting of Ag, Zn, Ti, Cd, Mg, Al, Ga, Si, Ge, In, Sn, Pb, Bi, Sb, oxides, sulfides, fluorides, nitrides, chlorides, and carbides thereof, and mixtures thereof.

In an eighth aspect according to any preceding aspect, the lithiophilic material has a weight percentage in a range from 10 wt % to 35 wt % in the anode protective layer.

In a nineth aspect according to any preceding aspect, the particle of the lithiophilic material is coated with a carbon doped with nitrogen, and wherein the carbon doped with nitrogen has a thickness in a range from 0.5 to 20 nm.

In a tenth aspect according to any preceding aspect, the carbonaceous material comprises at least one selected from the group consisting of carbon black, acetylene black, Ketjen black, channel black, furnace black, lamp black, thermal black, natural graphite and artificial graphite.

In an eleventh aspect according to any preceding aspect, the carbonaceous material has a weight percentage in a range from 60 wt % to 90 wt % in the anode protective layer.

In a twelfth aspect according to any preceding aspect, the particle of the lithiophilic material at least partially coated with a carbon layer doped with nitrogen is prepared by:
1) Forming a mixture comprising a metal salt as a precursor of the lithiophilic material and a nitrogen-containing carbon precursor, and,
2) Pyrolyzing the mixture in a furnace under a flowing gas, thus obtaining particle of the lithiophilic material at least partially coated with a carbon layer doped with nitrogen.

In some embodiments, the mixture is substantially free of other components. In some embodiments, the mixture consists of the metal salt and the nitrogen-containing carbon precursor.

In a thirteenth aspect according to the twelfth aspect, the metal salt and the nitrogen-containing carbon precursor have a weight ratio in a range from 100:1 to 100:100.

In a fourteenth aspect according to the twelfth or thirteenth aspect, the metal salt comprises at least one selected from the group consisting of metal acetate, metal nitrate, metal chloride, metal sulfate, metal carbonate, metal oxide and metal fluoride, and the nitrogen-containing carbon precursor comprises at least one selected from the group consisting of urea, melamine, cyanamide, pyridine, acrylonitrile, acetonitrile, phthalocyanine, polyacrylonitrile (PAN) and polyaniline.

In a fifteenth aspect, the present disclosure provides an anode assembly comprising the anode protective layer of any preceding aspect and an anode current collector. In some embodiments, the anode assembly does not have any anode active material layer, wherein the anode protective layer is on top of the anode current collector. In some embodiments, the anode assembly further comprises an anode active material layer, wherein the anode active material layer is disposed between the anode current collector and the anode active material layer. In some embodiments, the anode active material layer comprises lithium metal or lithium alloy.

In a sixteenth aspect, the present disclosure provides an electrochemical device comprising the anode assembly according to the fifteenth aspect.

In a seventeenth aspect according to the sixteenth aspect, the electrochemical device exhibits at least one of the following:
1) an initial specific capacity of at least 145 mAh/g at a rate of 0.33 C at a temperature of 45° C.,
2) a capacity retention of at least 90.0% after 50 cycles at a rate of 0.33 C at a temperature of 45° C.,
3) a capacity retention of at least 80.0% after 100 cycles at a rate of 0.33 C at a temperature of 45° C.,
4) a specific capacity of at least 140 mAh/g after 50 cycles at a rate of 0.33 C at a temperature of 45° C.,
5) a specific capacity of at least 130 mAh/g after 100 cycles at a rate of 0.33 C at a temperature of 45° C.,
6) an average CE of at least 99.40% for the first 50 cycles at a rate of 0.33 C at a temperature of 45° C., and
7) an average CE of at least 99.00% for the first 100 cycles at a rate of 0.33 C at 45° C.

In an eighteenth aspect, the present disclosure also provides a method for preparing an ASSB, comprising:
1) having an anode layer comprising an anode current collector and an anode protective layer according to the first aspect; and
2) laminating the anode layer, a solid electrolyte layer, and a cathode layer in the order, wherein the anode protective layer is located between the anode current collector and the solid electrolyte layer, thereby obtaining an ASSB comprising the anode layer, the solid electrolyte layer and the cathode layer.

In a nineteenth aspect according to the eighteenth aspect, the anode layer, the solid electrolyte layer and the cathode layer are laminated via an isostatic pressing (IP) process.

In a twentieth aspect according to the eighteenth or nineteenth aspect, the IP process is conducted at a stacking pressure in a range from 100 MPa to 500 MPa and at a temperature in a range from 20° C. to 100° C.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

What is claimed is:

1. An anode protective layer for an all-solid-state battery (ASSB), comprising a carbonaceous material and a coated particle of a lithiophilic material, wherein a carbon layer doped with nitrogen at least partially covers the lithiophilic material and the coated particle of the lithiophilic material is distributed in a matrix of the carbonaceous material.

2. The anode protective layer of claim 1, wherein the content of carbon of a surface of the coated particle is in a range from about 0.1 wt % to about 10.0 wt %, based on total content of the surface as determined by SEM-EDX.

3. The anode protective layer of claim 1, wherein the content of nitrogen of a surface of the coated particle is from about 0.1 wt % to about 10 wt %, based on total content of the surface as determined by SEM-EDX.

4. The anode protective layer of claim 1, wherein the content of oxygen of a surface of the coated particle is in a range from about 1.0 wt % to about 5.0 wt % based on total content of the surface as determined by SEM-EDX.

5. The anode protective layer of claim 1, wherein the coated particle has an average crystalline particle size in a range from 35 nm to 70 nm, wherein the average crystalline particle size is calculated by Debye-Scherrer equation: Kλ/β Cos θ, wherein K is the Scherrer constant (0.9), λ denotes the wavelength of the radiation source, β is the full width at half maximum (FWHM) of the peak with the highest density at a diffraction angel of θ.

6. The anode protective layer of claim 1, wherein the content of the lithiophilic material of the coated particle is in a range from 80.0 wt % to 98.5 wt %, based on total content of the particle surface, as determined by SEM-EDX.

7. The anode protective layer of claim 1, wherein the lithiophilic material comprises at least one selected from the group consisting of Ag, Zn, Ti, Cd, Mg, Al, Ga, Si, Ge, In, Sn, Pb, Bi, Sb, oxides, sulfides, fluorides, nitrides, chlorides, and carbides thereof, and mixtures thereof.

8. The anode protective layer of claim 1, wherein the lithiophilic material has a weight percentage in a range from 10 wt % to 35 wt % in the anode protective layer.

9. The anode protective layer of claim 1, wherein the carbon layer doped with nitrogen has a thickness in a range from 0.5 to 20 nm.

10. The anode protective layer of claim 1, wherein the carbon layer doped with nitrogen comprises a carbonaceous material comprising at least one selected from the group consisting of carbon black, acetylene black, Ketjen black, channel black, furnace black, lamp black, thermal black, natural graphite and artificial graphite.

11. The anode protective layer of claim 10, wherein the carbonaceous material has a weight percentage in a range from 60 wt % to 90 wt % in the anode protective layer.

12. The anode protective layer of claim 1, wherein the coated particle is prepared by:
1) Forming a mixture comprising a metal salt as a precursor of the lithiophilic material and a nitrogen-containing carbon precursor, and,
2) Pyrolyzing the mixture in a furnace under a flowing gas, thus obtaining a coated particle of the lithiophilic material, wherein a carbon layer doped with nitrogen at least partially covers the lithiophilic material.

13. The anode protective layer of claim 12, wherein the metal salt and the nitrogen-containing carbon precursor have a weight ratio in a range from 100:1 to 100:100.

14. The anode protective layer of claim 12, wherein the metal salt comprises at least one selected from the group consisting of metal acetate, metal nitrate, metal chloride, metal sulfate, metal carbonate, metal oxide and metal fluoride, and the nitrogen-containing carbon precursor comprises at least one selected from the group consisting of urea, melamine, cyanamide, pyridine, acrylonitrile, acetonitrile, phthalocyanine, polyacrylonitrile (PAN) and polyaniline.

15. An anode assembly comprising the anode protective layer of claim 1 and an anode current collector.

16. An electrochemical device comprising the anode assembly of claim 15.

17. The electrochemical device of claim 16, wherein the electrochemical device exhibits at least one of the following:
a) an initial specific capacity of at least 145 mAh/g at a rate of 0.33 C at 45° C.,
b) a capacity retention of at least 90.0% after 50 cycles at a rate of 0.33 C at 45° C.,
c) a capacity retention of at least 80.0% after 100 cycles at a rate of 0.33 C at 45° C.,
d) a specific capacity of at least 140 mAh/g after 50 cycles at a rate of 0.33 C at 45° C.,
e) a specific capacity of at least 130 mAh/g after 100 cycles at a rate of 0.33 C at 45° C.,
f) an average CE of at least 99.40% for the first 50 cycles at a rate of 0.33 C at 45° C., and
g) an average CE of at least 99.00% for the first 100 cycles at a rate of 0.33 C at 45° C.

18. A method for preparing an ASSB, comprising:
1) having an anode layer comprising an anode current collector and the anode protective layer of claim 1; and
2) laminating the anode layer, a solid electrolyte layer, and a cathode layer in the order, wherein the anode protective layer is located between the anode current collector and the solid electrolyte layer, thereby obtaining an ASSB comprising the anode layer, the solid electrolyte layer and the cathode layer.

19. The method of claim 18, wherein the anode layer, the solid electrolyte layer and the cathode layer are laminated via an isostatic pressing (IP) process.

20. The method of claim 19, wherein the IP process is conducted at a stacking pressure in a range from 100 MPa to 500 MPa at a temperature in a range from 20° C. to 100° C.
